(19) United States
(12) Patent Application Publication
(10) Pub. No.: US 2008/0152879 A1
(43) Pub. Date: Jun. 26, 2008

(54) TRANSPARENT CONDUCTIVE LAMINATE AND TOUCH PANEL

(75) Inventors: Tomotake Nashiki, Osaka (JP); Hideo Sugawara, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/951,011

(22) Filed: Dec. 5, 2007

(30) Foreign Application Priority Data
Dec. 7, 2006 (JP) 2006-330794

(51) Int. Cl. B32B 7/02

(52) U.S. Cl. 428/212

(57) ABSTRACT

A transparent conductive laminate includes: a first transparent dielectric thin film; a second transparent dielectric thin film; a transparent conductive thin film; a transparent film substrate having a thickness of 2 μm to 200 μm, and the first transparent dielectric thin film, the second transparent dielectric thin film, and the transparent conductive thin film formed on one side of the substrate in this order; a transparent pressure-sensitive adhesive layer; and a transparent base substrate bonded to another side of the transparent film substrate with a transparent pressure-sensitive adhesive layer interposed therebetween, wherein the first transparent dielectric thin film is formed by vacuum deposition, sputtering or ion plating and comprises a complex oxide containing 100 parts by weight of indium oxide, 0 to 20 parts by weight of tin oxide and 10 to 40 parts by weight of cerium oxide, a refractive index n1 of the first transparent dielectric thin film, a refractive index n2 of the second transparent dielectric thin film, and a refractive index n3 of the transparent conductive thin film satisfy a relationship: n2<n3≦n1, and the transparent base substrate is a transparent laminated base substrate having at least two transparent base films that are laminated with the transparent pressure-sensitive adhesive layer interposed therebetween.

### BACKGROUND OF THE INVENTION

1. Field of the Invention

The present invention relates to a transparent conductive laminate including a film substrate and a conductive thin film provided on the film substrate and having transparency in the visible light range. The transparent conductive laminate of the invention may be used for transparent electrodes in advanced display systems, such as liquid crystal displays and electroluminescence displays, and touch panels, and also used for prevention of static charge of transparent products or electromagnetic wave shielding.

2. Description of the Related Art

Concerning conventional transparent conductive thin films, the so-called conductive glass is well known, in which an indium oxide thin film is formed on a glass member. Since the base member of the conductive glass is made of glass, it has low flexibility or workability and cannot be used for certain purposes. In recent years, therefore, transparent conductive films using various types of plastic films such as polyethylene terephthalate films as their substrate have been preferably used, because of their advantages such as good impact resistance and light weight as well as flexibility and workability.

However, such conventional transparent conductive thin films using film substrates not only have the problem of low transparency due to high light reflectance of the thin film surface but also have the problem of low scratch resistance so that they can get scratched to have an increased electrical resistance or suffer from disconnection during use. Particularly when used in a touch panel, a pair of conductive thin films are opposed to each other with a spacer interposed therebetween and strongly brought into contact with each other by pressing and hitting from one panel plate side. Thus, it is desired that the conductive thin films have good durability to withstand the circumstances and thus have good tapping durability. However, the above-mentioned transparent conductive thin films using film substrates have low tapping durability and thus have a problem in which they can form short-life touch panels.

In order to solve the problem, there is proposed a transparent conductive laminate including: a film substrate with a specific thickness; a transparent dielectric thin film that has a light refractive index smaller than that of the film substrate and is formed on one side of the film substrate; a transparent conductive thin film sequentially formed on the transparent dielectric thin film; and another transparent base substrate bonded to the other side of the film substrate with a transparent pressure-sensitive adhesive layer interposed therebetween (see Japanese Patent Application Laid-Open (JP-A) No. 06-222352). Such a transparent conductive laminate can have improved transparency and improved scratch resistance of the conductive thin film and provides an improvement in the tapping durability of touch panels.

There is also proposed a transparent conductive laminate including a transparent film substrate, and a first transparent dielectric thin film, a second transparent dielectric thin film and a transparent conductive thin film that are formed on one side of the film substrate in this order from the side of the substrate, wherein the laminate satisfies the relationship: the refractive index of the second transparent dielectric thin film<the refractive index of the film substrate≦the refractive index of the first transparent dielectric thin film<the refractive index of the transparent conductive thin film (see JP-A No. 2002-326301). Such a transparent conductive laminate can form a touch panel that shows improved tapping durability when used in a bended form. According to JP-A No. 2002-326301, however, a mixture of organic and inorganic materials is used for the first transparent dielectric thin film formed on the transparent film substrate, and thus it is not easy to adjust optical properties such as transparency. There is also proposed a transparent conductive laminate including a transparent film substrate, and a first transparent dielectric thin film, a second transparent dielectric thin film and a transparent conductive thin film that are formed on one side of the film substrate in this order from the side of the film substrate, wherein the laminate satisfies the relationship: the second transparent dielectric thin film<the transparent conductive thin film≦the first transparent dielectric thin film (see JP-A No. 2000-301648). This transparent conductive laminate is disclosed to be able to suppress coloration of transmitted light. JP-A No. 2000-301648 discloses various methods for forming the first transparent dielectric thin film on the transparent film substrate, but none of the methods has a sufficient rate of film production.

Touch panels can be classified according to the position sensing method into an optical type, an ultrasonic type, a capacitive type, a resistive film type, and the like. In particular, the resistive film type has a relatively simple structure and thus is cost-effective so that it has come into wide use in recent years. For example, resistive film type touch panels are used for automatic teller machines (ATMs) in banks and for display panels of transportation ticket machines and the like.

The resistive film type touch panels are configured to include a transparent conductive laminate and a transparent conductive thin film-attached glass member that are opposed to each other with a spacer interposed therebetween, in which an electric current is allowed to flow through the transparent conductive laminate, while the voltage at the transparent conductive film-attached glass member is measured. When the transparent conductive laminate is brought into contact with the transparent conductive film-attached glass member by pressing with a finger, a pen or the like, the electric current flows through the contact portion so that the position of the contact portion is detected.

In recent years, the market for touch panels to be installed in smartphones, personal digital assistances (PDAs), game computers, and the like is expanding, and the frame part of touch panels becomes narrower. This increases the opportunity to push touch panels with fingers so that not only requirements for pen input durability but also requirements for surface pressure durability should be satisfied. However, the techniques disclosed in the patent literatures cannot achieve satisfactory pen input durability and thus can never achieve satisfactory surface pressure durability.

### SUMMARY OF THE INVENTION

It is an object of the invention to provide a transparent conductive laminate that includes a transparent film substrate, and a first transparent dielectric thin film, a second transparent dielectric thin film and a transparent conductive thin film formed on one side of the substrate in this order from the side of the substrate and that has high transparency and good productivity and also has pen input durability and surface pressure durability. It is another object of the invention to provide a touch panel using such a transparent conductive laminate.

As a result of investigations to solve the above problems, the inventors have found that the above objects can be achieved with the transparent conductive laminate described below, and have finally completed the invention.

Namely, the transparent conductive laminate of the present invention is a transparent conductive laminate, comprising: a first transparent dielectric thin film; a second transparent dielectric thin film; a transparent conductive thin film; a transparent film substrate having a thickness of 2 μm to 200 μm, and the first transparent dielectric thin film, the second transparent dielectric thin film, and the transparent conductive thin film formed on one side of the substrate in this order; a transparent pressure-sensitive adhesive layer; and a transparent base substrate bonded to another side of the transparent film substrate with a transparent pressure-sensitive adhesive layer interposed therebetween, wherein the first transparent dielectric thin film is formed by vacuum deposition, sputtering or ion plating and comprises a complex oxide containing 100 parts by weight of indium oxide, 0 to 20 parts by weight of tin oxide and 10 to 40 parts by weight of cerium oxide, a refractive index n1 of the first transparent dielectric thin film, a refractive index n2 of the second transparent dielectric thin film, and a refractive index n3 of the transparent conductive thin film satisfy a relationship: n2<n3≦n1, and the transparent base substrate is a transparent laminated base substrate having at least two transparent base films that are laminated with the transparent pressure-sensitive adhesive layer interposed therebetween.

In the above, it is preferable that the first transparent dielectric thin film has a thickness of 10 nm to 200 nm and a surface resistance of 1×10⁶ Ω/square or more.

In the above, it is preferable that the transparent conductive laminate further includes a resin layer provided on an outer surface of the transparent base substrate.

Also, a touch panel of the present invention includes; a pair of panel plates each having a transparent conductive thin film; and a spacer interposed between a pair of the panel plates opposed to each other in such a manner that the transparent conductive thin films are opposed to each other, wherein at least one of a pair of the panel plates comprises above the transparent conductive laminate.

According to the invention, the first transparent dielectric thin film is made of a complex oxide that contains indium oxide and specific amounts of tin oxide and cerium oxide based on the amount of the indium oxide. The complex oxide comprises a complex of indium oxide and tin oxide that is a transparent conductive material, and cerium oxide with which the complex is doped. The complex oxide can achieve a high refractive index equal to or higher than the refractive index of the transparent conductive thin film. This leads to a large difference between the refractive indexes of the first and second transparent dielectric thin films so that optical adjustment can easily be performed and therefore a transparent conductive laminate with high transmittance and good optical properties such as good transparency can be achieved.

The first transparent dielectric thin film made of the complex oxide according to the invention has high surface resistance and can be adjusted so as to have a high resistance value that will not affect the electrical conductivity of the transparent conductive thin film. The surface resistance of the first transparent dielectric thin film preferably provides insulating properties (high resistance values) in such a manner that the electrical conductivity of the transparent conductive thin film is not affected, and is preferably 1×10⁶ Ω/square or more, more preferably 1×10⁸ Ω/square or more.

The complex oxide according to the invention has high refractive index, and thin films thereof can be produced with high productivity (at high sputtering rate) by sputtering, which is commonly employed to form thin films. Examples of high refractive index materials that are conventionally used include TiO₂ (2.35), Nd₂O₃ (2.15), ZrO₂ (2.05), Ta₂O₅ (2.2), ZnO (2.1), In₂O₃ (2.0), SnO₂ (2.0), and the like, wherein values in parentheses are the light refractive indexes of the respective materials. Among these materials, however, thin films of TiO₂, Nd₂O₃, ZrO₂, Ta₂O₅, ZnO, or the like are produced with low productivity (at low sputtering rate) by sputtering, which is commonly employed to form thin films. Thin films of In₂O₃, SnO₂ or the like are produced with high productivity, but they have low surface resistance values and affect the electrical conductivity of the transparent conductive thin film and thus are not suited for the first transparent dielectric thin film.

The transparent conductive laminate of the invention has two transparent dielectric thin films including the first and second transparent dielectric thin films between the transparent conductive thin film and the film substrate. Such a structure also has good scratch resistance and good bending properties. In addition, the first transparent dielectric thin film uses a high-refractive-index, high-resistance complex oxide having a specific content of a specific component and is formed by a dry process, as described above, so that coloration of transmitted light can be suppressed, the productivity can be high, and optical adjustment can be easily performed.

According to the invention, the transparent conductive laminate is also configured to include a transparent laminated base substrate that includes at least two transparent base films laminated with a transparent pressure-sensitive adhesive layer interposed therebetween and is provide on the side of the transparent film substrate where no transparent conductive film is provided. Such a structure can improve not only pen input durability but also surface pressure durability, for example, when the transparent conductive laminate is used for touch panels.

The pen input durability and surface pressure durability of the transparent conductive laminate are further improved, because the transparent conductive thin film is provided on the side of the film substrate with the transparent dielectric thin films interposed therebetween. Specifically, the dielectric thin films effectively serve as an undercoat layer of the transparent conductive thin film to improve in-plane durability.

### BRIEF DESCRIPTION OF THE DRAWINGS

FIG. 1 is a cross-sectional view showing an example of a transparent conductive laminate of the invention;

FIG. 2 is a cross-sectional view showing an example of a touch panel of the invention;

FIG. 3 is a schematic cross-sectional view for illustrating a surface-pressure durability test for touch panels according to examples of the invention; and

FIG. 4 is a graph showing the relationship between the voltage value and the location of measurement with respect to the touch panel obtained in example 1.

### DETAILED DESCRIPTION OF THE PREFERRED EMBODIMENTS

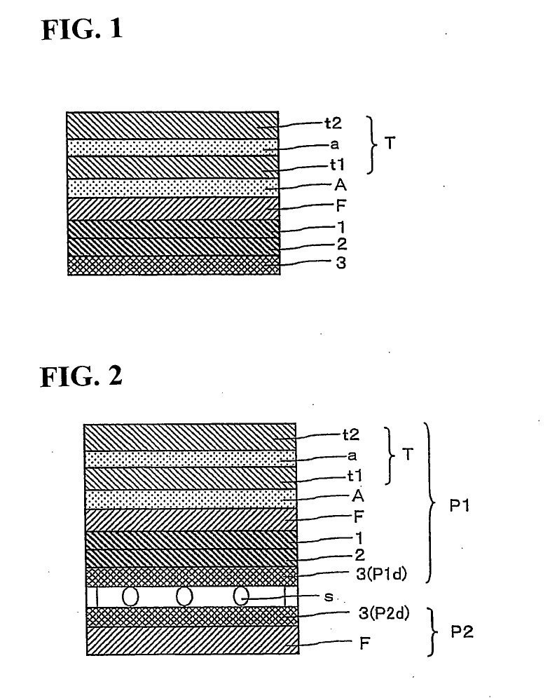

The transparent conductive laminate of the invention will be described below with reference to the drawings. FIG. 1 shows an example of the transparent conductive laminate of the invention, which includes a transparent film substrate F, first and second transparent dielectric thin films 1 and 2 formed on one side of the substrate F, and a transparent conductive thin film 3 formed on the second transparent dielectric thin film 2.

A transparent laminated base substrate T is bonded to the other side of the film substrate F of the transparent conductive laminate with a transparent pressure-sensitive adhesive layer A interposed therebetween. The transparent laminated base substrate T includes a transparent base film t1 and another transparent base film t2 that are laminated with a transparent pressure-sensitive adhesive layer a interposed therebetween. While FIG. 1 illustrates a case where two transparent base films are laminated, two or more transparent base films may be laminated, and specifically three, four, five, or more transparent base films may be laminated. Such a structure can further increase in-plane durability. Although not shown, a hard-coating layer (resin layer) or the like may be provided on the outer surface of the transparent laminated base substrate T of FIG. 1.

There is no particular limitation to the film substrate F, and various types of plastic films having transparency may be used. Examples of the material for the film substrate F include polyester resins, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. Above all, polyester resins are preferred in view of cost. In general, the film substrate F to be used preferably has a refractive index of about 1.4 to about 1.7.

The film substrate F has a thickness in the range of 2 to 200 μm, particularly in the range of 20 to 150 μm. If the thickness is less than 2 μm, the substrate can have inadequate mechanical strength, and it can be difficult to use the substrate into a roll form for continuous production of the first or second transparent dielectric thin film and the transparent conductive thin film and further the pressure-sensitive adhesive layer. A thickness of more than 200 μm is not preferred in view of marketing needs such as lightweight and small thickness.

The surface of the film substrate F may be previously subject to sputtering, corona discharge treatment, flame treatment, ultraviolet irradiation, electron beam irradiation, chemical treatment, etching treatment such as oxidation, hard coating, or undercoating treatment such that the adhesion of the first transparent dielectric thin film 1 formed thereon to the transparent base substrate T can be improved. If necessary, the film substrate may also be subjected to dust removing or cleaning by solvent cleaning, ultrasonic cleaning or the like, before the first transparent dielectric thin film 1 is formed.

The first transparent dielectric thin film 1, the second transparent dielectric thin film 2 and the transparent conductive thin film 3 are formed in this order on the film substrate F. The light refractive index n1 of the first transparent dielectric thin film 1, the light refractive index n2 of the second transparent dielectric thin film 2, and the light refractive index n3 of the transparent conductive thin film 3 satisfy the relationship: n2<n3≦n1. The light refractive index n3 of the transparent conductive thin film 3 is generally about 2 (typically from 1.9 to 2.1), and therefore in such a case, the light refractive index n1 of the first transparent dielectric thin film 1 is generally from about 1.9 to about 2.3, preferably from 2.0 to 2.2, and the light refractive index n2 of the second transparent dielectric thin film 2 is generally from about 1.3 to about 1.7, preferably from 1.4 to 1.6.

The first transparent dielectric thin film 1 is made of a complex oxide that contains indium oxide and specific amounts of tin oxide and cerium oxide based on 100 parts by weight of the indium oxide. A sintered body of a mixture of the respective oxide components is preferably used as a material for forming the thin film 1. In the complex oxide, the content of tin oxide is from 0 to 20 parts by weight, preferably from 3 to 15 parts by weight, based on 100 parts by weight of indium oxide, in view of optical properties. If the content of tin oxide is more than 20 parts by weight, the sintered body for use as the material for forming the thin film can have lower sintered density so that an electric discharge can hardly remain stable during the film production (the electric discharge stability can be poor). The content of cerium oxide is from 10 to 40 parts by weight, preferably from 15 to 30 parts by weight, based on 100 parts by weight of indium oxide, in view of high resistance (insulating properties) and optical properties. A cerium oxide content of less than 10 parts by weight is not preferred, because in such a case, the surface resistance of the first transparent dielectric thin film 1 can be so low that it can have electrical conductivity. A cerium oxide content of more than 40 parts by weight is not preferred because in such a case, the productivity (sputtering rate for film production) can be reduced.

The thickness of the first transparent dielectric thin film 1 is preferably, but not limited to, from 10 to 200 nm, more preferably from 15 to 60 nm. When the first transparent dielectric thin film 1 has a thickness of less than 10 nm, it can be difficult to produce the film in the form of a continuous coating. The thickness is preferably 200 nm or less in view of optical adjustment.

Examples of materials for the second transparent dielectric thin film 2 include inorganic materials such as NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein the value in each parenthesis is the light refractive index of each material, and organic materials with a light refractive index of about 1.4 to about 1.6, such as acrylic resins, urethane resins, siloxane polymers, alkyd resins, and melamine resins. Any appropriate one or combination of these materials may be selected and used to form the second transparent dielectric thin film 2 with a refractive index n2 satisfying the above requirements.

The thickness of the second transparent dielectric thin film 2 is preferably, but not limited to, 10 nm or more, more preferably from 10 to 300 nm, particularly preferably from 20 to 120 nm, in terms of producing the film in the form of a continuous coating and in terms of improving transparency or scratch resistance. If the total thickness of the first and second transparent dielectric thin films 1 and 2 is too large, the improvement in transparency cannot be expected, and cracking can occur. Thus, the total thickness is preferably 150 nm or less, more preferably 100 nm or less.

Examples of materials that may be used for the transparent conductive thin film 3 include, but are not limited to, indium oxide doped with tin oxide, tin oxide doped with antimony, and the like.

The thickness of the transparent conductive thin film 3 is preferably, but not limited to, 10 nm or more, in terms of producing the film in the form of a continuous coating with a surface resistance of 1×10³ Ω/square or less and good electrical conductivity. If the thickness of the film is too large, the transparency and the like can be reduced, and thus the thickness is preferably from about 10 to about 300 nm.

The first transparent dielectric thin film 1, the second transparent dielectric thin film 2 and the transparent conductive thin film 3 are generally formed in this order sequentially on the film substrate F. Examples of the methods for forming the first transparent dielectric thin film 1 and the transparent conductive thin film 3 include vacuum vapor deposition methods, sputtering methods, and ion plating methods. Any appropriate method may be employed depending on the type of the materials and the desired film thickness. In particular, sputtering methods are typically used. The second transparent dielectric thin film 2 may be formed by any of the above methods or any other methods such as coating methods.

The other side of the film substrate F provided with the first transparent dielectric thin film 1, the second transparent dielectric thin film 2 and the transparent conductive thin film 3 is bonded to the transparent laminated substrate T with the transparent pressure-sensitive adhesive layer A interposed therebetween. The transparent laminated substrate T has a composite structure comprising at least two transparent base films bonded to each other with a transparent pressure-sensitive adhesive layer. The composite structure can improve the pen input durability and also the surface pressure durability.

In general, a thickness of the transparent laminated substrate T is preferably controlled to be from 90 to 300 μm, more preferably from 100 to 250 μm. The thickness of each base film constituting the transparent laminated substrate T may be from 10 to 200 μm, preferably from 20 to 150 μm, and may be controlled such that the total thickness of the transparent laminated substrate T including these base films and the transparent pressure-sensitive adhesive layer(s) can fall within the above range. Examples of the material for the base film include those for the film substrate F.

The film substrate F and the transparent laminated substrate T may be bonded by a process including the steps of forming the pressure-sensitive adhesive layer A on the transparent laminated substrate T side and bonding the film substrate F thereto or by a process including the steps of forming the pressure-sensitive adhesive layer A contrarily on the film substrate F side and bonding the transparent laminated substrate T thereto. The latter process is more advantageous in view of productivity, because it enables continuous production of the pressure-sensitive adhesive layer A with the film substrate F in the form of a roll. Alternatively, the transparent laminated substrate T may be formed on the film substrate F by sequentially laminating the base films t1 and t2 with the pressure-sensitive adhesive layers A and a. The transparent pressure-sensitive adhesive layer (the pressure-sensitive adhesive layer a in FIG. 1) for use in laminating the base films may be made of the same material as the transparent pressure-sensitive adhesive layer A described below.

Any transparent pressure-sensitive adhesive may be used for the pressure-sensitive adhesive layer A without limitation. For example, the pressure-sensitive adhesive may be appropriately selected from adhesives based on polymers such as acrylic polymers, silicone polymers, polyester, polyurethane, polyamide, polyvinyl ether, vinyl acetate-vinyl chloride copolymers, modified polyolefins, epoxy polymers, fluoropolymers, and rubbers such as natural rubbers and synthetic rubbers. In particular, acrylic pressure-sensitive adhesives are preferably used, because they have good optical transparency and good weather or heat resistance and exhibit suitable wettability and adhesion properties such as cohesiveness and adhesiveness.

The anchoring strength can be improved using an appropriate pressure-sensitive adhesive primer, depending on the type of the pressure-sensitive adhesive as a material for forming the pressure-sensitive adhesive layer A. In the case of using such a pressure-sensitive adhesive, therefore, a certain pressure-sensitive adhesive primer is preferably used.

The pressure-sensitive adhesive primer may be of any type as long as it can improve the anchoring strength of the pressure-sensitive adhesive. For example, the pressure-sensitive adhesive primer that may be used is a so-called coupling agent such as a silane coupling agent having a hydrolyzable alkoxysilyl group and a reactive functional group such as amino, vinyl, epoxy, mercapto, and chloro in the same molecule, a titanate coupling agent having an organic functional group and a titanium-containing hydrolyzable hydrophilic group in the same molecule, and an aluminate coupling agent having an organic functional group and an aluminum-containing hydrolyzable hydrophilic group in the same molecule; or a resin having an organic reactive group, such as an epoxy resin, an isocyanate resin, a urethane resin, and an ester urethane resin. In particular, a silane coupling agent-containing layer is preferred, because it is easy to handle industrially.

The pressure-sensitive adhesive layer A may contain a crosslinking agent depending on the base polymer. If necessary, the pressure-sensitive adhesive layer A may also contain appropriate additives such as natural or synthetic resins, glass fibers or beads, or fillers comprising metal powder or any other inorganic powder, pigments, colorants, and antioxidants. The pressure-sensitive adhesive layer A may also contain transparent fine particles so as to have light diffusing ability.

The transparent fine particles to be used may be one or more types of appropriate conductive inorganic fine particles of silica, calcium oxide, alumina, titania, zirconia, tin oxide, indium oxide, cadmium oxide, antimony oxide, or the like with an average particle size of 0.5 to 20 μm or one or more types of appropriate crosslinked or uncrosslinked organic fine particles of an appropriate polymer such as poly(methyl methacrylate) and polyurethane with an average particle size of 0.5 to 20 μm.

The pressure-sensitive adhesive layer A is generally formed using a pressure-sensitive adhesive solution with a solids content of about 10 to about 50% by weight, in which a base polymer or a composition thereof is dissolved or dispersed in a solvent. An organic solvent such as toluene and ethyl acetate, water, or any other solvent may be appropriately selected depending on the type of the pressure-sensitive adhesive and used as the above solvent.

After the bonding of the transparent laminated substrate T, the pressure-sensitive adhesive layer A has a cushion effect and thus can function to improve the scratch resistance of the conductive thin film formed on one side of the film substrate F or to improve the tap properties thereof for touch panels, such as so called pen input durability and surface pressure durability. In terms of performing this function better, it is preferred that the elastic modulus of the pressure-sensitive adhesive layer A should be set in the range of 1 to 100 N/cm² and that its thickness should be set at 1 μm or more, generally in the range of 5 to 100 μm.

If the elastic modulus is less than 1 N/cm², the pressure-sensitive adhesive layer A can be inelastic so that the pressure-sensitive adhesive layer can easily deform by pressing to make the film substrate F irregular and further to make the conductive thin film 3 irregular. If the elastic modulus is less than 1 N/cm², the pressure-sensitive adhesive can easily squeeze out of the cut section, and the effect of improving the scratch resistance of the conductive thin film 3 or improving the tap properties of the thin film 3 for touch panels can be reduced. If the elastic modulus is more than 100 N/cm², the pressure-sensitive adhesive layer A can be hard, and the cushion effect cannot be expected, so that the scratch resistance of the conductive thin film 3 or the pen input durability and surface pressure durability of the thin film 3 for touch panels can tend to be difficult to improve.

If the thickness of the pressure-sensitive adhesive layer A is less than 1 μm, the cushion effect also cannot be expected so that the scratch resistance of the conductive thin film 3 or the pen input durability and surface pressure durability of the thin film 3 for touch panels can tend to be difficult to improve. If it is too thick, it can reduce the transparency, or it can be difficult to obtain good results on the formation of the pressure-sensitive adhesive layer A, the bonding workability of the transparent laminated substrate T, and the cost.

The transparent laminated substrate T bonded through the pressure-sensitive adhesive layer A as described above imparts good mechanical strength to the film substrate F and contributes to not only the pen input durability and the surface pressure durability but also the prevention of curling.

The pressure-sensitive adhesive layer A may be transferred using a separator. In such a case, for example, the separator to be used may be a laminate of a polyester film of a migration-preventing layer and/or a release layer, which is provided on a polyester film side to be bonded to the pressure-sensitive adhesive layer A.

If necessary, an antiglare or antireflection layer for improving visibility or a hard coat layer for protecting the outer surface may be formed on the outer surface of the transparent laminated substrate T (on the side opposite to the pressure-sensitive adhesive layer). For example, the hard coat layer is preferably made of a cured coating film of a curable resin such as a melamine resin, a urethane resin, an alkyd resin, an acrylic resin, a silicone resin, and an epoxy resin.

FIG. 2 illustrates an example of the touch panel using the transparent conductive laminate (FIG. 1) of the invention. Specifically, the touch panel includes a pair of panel plates P1 and P2 that have stripe-shaped transparent conductive thin films P1d and P2d, respectively and are arranged opposite to each other with a spacer S interposed therebetween in such a manner that the stripe-shaped transparent conductive thin films P1d and P2d are orthogonal and opposite to each other. In such a touch panel, the transparent conductive laminate shown in FIG. 1 is used as one of the panel plates (P1).

The touch panel functions as a transparent switch substrate in which contact between the conductive thin films P1d and P2d by tapping with an input pen or the like on the panel plate P1 side against the elastic force of the spacer S produces the electrically ON state, while removal of the press turns it to the original OFF state. In this structure, the panel plate P1 is made of the transparent conductive laminate described above, and, therefore, the transparent conductive thin films are superior in scratch resistance, tapping durability, pen input durability, surface pressure durability, and the like, so that the touch panel can stably maintain the above function over a long period of time.

In FIG. 2, the panel plate P1 may be the transparent conductive laminate shown in FIG. 1. The panel plate P2 includes a transparent base substrate F made of a plastic film, a glass plate or the like, and a transparent conductive thin film P2d provided thereon. Alternatively, the transparent conductive laminate shown in FIG. 1 may also be used as the panel plate P2, like the panel plate P1.

### EXAMPLES

The invention will be more specifically described by showing examples below. Hereinafter, “part or parts” means part or parts by weight.

### Refractive Index and Thickness of Each Layer

The refractive index and thickness of each of the transparent dielectric thin film and the transparent conductive thin film were calculated by optical simulation which included laminating a single layer of the thin film under the corresponding coating conditions on an appropriate thermoplastic film substrate different in refractive index from the transparent dielectric thin film or the transparent conductive thin film, measuring the optical reflection spectrum on the surface of the laminated layer, determining the wavelength for the maximum or minimum reflectance peak that was produced on the spectrum based on an optical interference effect, and using the wavelength and the value of the peak reflectance for the calculation. The refractive index of the hard coat layer was measured with an Abbe refractometer (at a measurement wavelength of 590 nm), and the thickness of the hard coat layer was calculated using the optical interference method similarly to the case of the transparent dielectric thin film. The surface resistance (Ω/square) of the first transparent dielectric thin film was measured with a Highrester resistance meter manufactured by Mitsubishi Chemical Co., Ltd., and the thickness of the first transparent dielectric thin film was measured with a transmission electron microscope H-7650 manufactured by Hitachi, Ltd.

### Example 1

### Formation of First Transparent Dielectric Thin Film

A first transparent dielectric thin film (with a light refractive index n1 of 2.1) of a complex oxide containing 100 parts of indium oxide, 10 parts of tin oxide and 25 parts of cerium oxide was formed by a reactive sputtering method under the conditions below in a mixed gas atmosphere of 95% argon gas and 5% oxygen gas from a sintered body of a mixture of 100 parts of indium oxide, 10 parts of tin oxide and 25 parts of cerium oxide on one side of a film substrate (with a light refractive index nf of 1.66) made of a 125 μm-thick polyethylene terephthalate film (hereinafter referred to as PET film). The first transparent dielectric thin film had a thickness of 32 nm and a surface resistance of 8.5×10⁹ Ω/square.

### Sputtering Conditions

Target Size: 200 mm×500 mm
Power: 3.0 kW
Voltage: 450 V
Discharge Time: 1 minute
Degree of Vacuum: 0.5 Pa

### Formation of Second Transparent Dielectric Thin Film

SiO₂ (with a light refractive index n2 of 1.46) was vapor-deposited at a vacuum degree of 1×10⁻² to 3×10⁻² Pa by an electron-beam heating method to form a 50 nm-thick second transparent dielectric thin film on the first transparent dielectric thin film.

### Formation of Transparent Conductive Thin Film

On the thin SiO₂ film, a transparent conductive thin film (with a light refractive index n3 of 2.0) of a complex oxide containing 100 parts of indium oxide and 10 parts of tin oxide was formed by a reactive sputtering method using a mixed gas of 95% argon gas and 5% oxygen gas in a 0.5 Pa atmosphere from a sintered body of a mixture of 100 parts of indium oxide and 10 parts of tin oxide.

### Formation of Hard Coat Layer

A toluene solution as a material for forming a hard coat layer was prepared by adding 5 parts of hydroxycyclohexyl phenyl ketone (Irgacure 184, manufactured by Ciba Specialty Chemicals Inc.) as a photopolymerization initiator to 100 parts of an acrylic urethane resin (Unidic 17-806, manufactured by Dainippon Ink and Chemicals, Incorporated) and diluting the mixture with toluene to a concentration of 30% by weight.

The hard coat layer-forming material was applied to one side of a base film made of a 125 μm-thick PET film and dried at 100° C. for 3 minutes. The coating was then immediately irradiated with ultraviolet light from two ozone-type high-pressure mercury lamps (each 80 W/cm² in energy density, 15 cm focused radiation) to form a 5 μm-thick hard coat layer.

### Preparation of Transparent Laminated Substrate

An about 20 μm-thick transparent acrylic pressure-sensitive adhesive layer with an elastic modulus of 10 N/cm² was formed on the other side of the base film opposite to the hard coat layer-receiving side. The pressure-sensitive adhesive layer was formed using a composition prepared by adding one part of an isocyanate crosslinking agent to 100 parts of an acrylic copolymer of butyl acrylate, acrylic acid and vinyl acetate (100:2:5 in weight ratio). Another base film made of a 25 μm-thick PET film was bonded to the pressure-sensitive adhesive layer side so that a transparent laminated base substrate including the two PET films was obtained.

### Preparation of Transparent Conductive Laminate

Under the same conditions as described above, a pressure-sensitive adhesive layer was formed on the other side of the transparent laminated base substrate opposite to the hard coat layer-receiving side, and the pressure-sensitive adhesive layer side was bonded to the film substrate (on the side where no conductive thin film was formed) so that a transparent conductive laminate according to this example was prepared.

### Example 2

### Formation of Second Transparent Dielectric Thin Film

A wet SiO₂ film was formed on the same first transparent dielectric thin film as obtained in example 1 (see the section “Formation of First Transparent Dielectric Thin Film”) by a silica coating method. Specifically, a silica sol (Colcoat P, manufactured by Colcoat Co., Ltd.) was diluted with ethanol to a solid concentration of 2% and then applied to the first transparent dielectric thin film. The coating was dried at 150° C. for 2 minutes and then cured to form a 30 nm-thick wet SiO₂ film (with a relative refractive index of 1.46).

### Preparation of Transparent Conductive Laminate

A transparent conductive thin film was formed, and then a transparent conductive laminate was prepared, using the process of example 1, except that the second transparent dielectric thin film was formed by the above-described method.

### Example 3

### Formation of First Transparent Dielectric Thin Film

A transparent hard-coat layer (with a light refractive index of 1.54) was formed on a 25 μm-thick PET film by a process including the steps of mixing 100 parts of an ultraviolet curable resin (KRX571-76NL manufactured by Asahi Denka Kogyo K.K.) and 0.5 parts of a silicone-based leveling agent and diluting them with a solvent so as to form a solution with a solids content of 20%, applying the solution with a No. 16 wire bar such that the film would have a thickness of 3 μm after drying, vaporizing the solvent with a drying oven, and then curing the coating by application of ultraviolet light from a high pressure mercury lamp.

A first transparent dielectric thin film was formed using the process of example 1, except that the PET film provided with the hard-coat layer was used as the film substrate and that a sintered body of a mixture of 100 parts of indium oxide, 5 parts of tin oxide and 10 parts of cerium oxide was used in the reactive sputtering method so that the first transparent dielectric thin film (with a light refractive index n1 of 2.05) was formed of a complex oxide containing 100 parts of indium oxide, 5 parts of tin oxide and 10 parts of cerium oxide on the hard-coat layer. The first transparent dielectric thin film had a thickness of 35 nm and a surface resistance of 5.7×10⁷ Ω/square.

A second transparent dielectric thin film was then formed on the first transparent dielectric thin film in the same way as in example 1, and a transparent conductive thin film was also formed in the same way as in example 1. The film substrate (the side where no transparent conductive thin film was formed) was then bonded to the transparent laminated base substrate in the same way as in example 1 so that a transparent conductive laminate was obtained.

### Comparative Example 1

A transparent conductive laminate was prepared using the process of example 1, except that a transparent base substrate composed of a 125 μm-thick PET film as a base film and a hard-coat layer formed thereon (without the 25 μm-thick PET base film bonded in the transparent laminated base substrate of example 1) was used in place of the transparent laminated substrate.

### Comparative Example 2

A transparent conductive laminate was prepared using the process of example 2, except that a transparent base substrate composed of a 125 μm-thick PET film as a base film and a hard-coat layer formed thereon (without the 25 μm-thick PET base film bonded in the transparent laminated base substrate of example 1) was used in place of the transparent laminated substrate.

The transparent conductive laminates obtained in the examples and the comparative examples were evaluated as described below. The results are shown in table 1.

### Sputtering Rate

Sputtering rates are shown for the first transparent dielectric thin film under the sputtering conditions described in example 1. A constant sputtering rate is preferred under the sputtering conditions described in example 1.

### Surface Resistance of Transparent Conductive Thin Film

The surface resistance (Ω/square) was measured using a Lowrester resistance meter manufactured by Mitsubishi Chemical Co., Ltd. The transparent conductive thin film was designed to have a surface resistance of 450 Ω/square, and its actual surface resistance preferably does not vary from 450 Ω/square.

### Light Transmittance

Visible light transmittance was measured at a light wavelength of 550 nm using a spectrophotometer UV-240 manufactured by Shimadzu Corporation.

### Optical Properties

The hue b* was measured using a spectrophotometer UV3150 manufactured by Shimadzu Corporation. The hue b* is an indicator of coloration of transmitted light. As the value of the hue b* increases on the negative side, transmitted light becomes bluer. As the value of the hue b* increases on the positive side, transmitted light becomes yellower. The value of the hue b* is preferably in the range of −2 to 2 so that coloration can be suppressed.

### Surface Pressure Durability

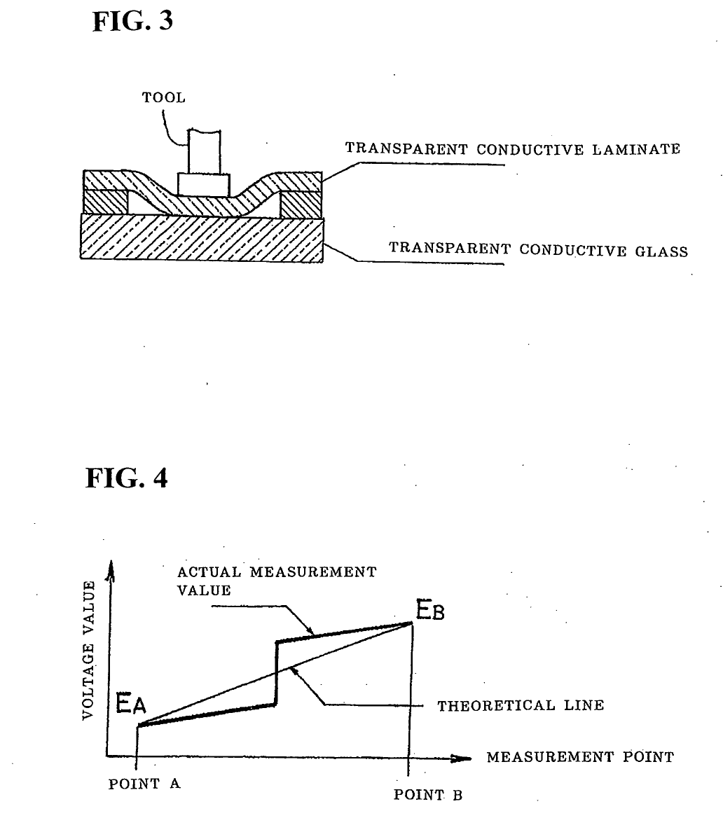

As shown in FIG. 3, a surface pressure durability test tool (20 mmφ in contact diameter) was pressed against each touch panel under a load of 2 kg (the coefficient of friction was from 0.7 to 1.3 when the tool was in contact with the touch panel), while the tool was allowed to slide on each touch panel. After the sliding under specific conditions, linearity was measured for an evaluation of surface pressure durability. The sliding was performed on the transparent conductive laminate side in an area at least 5 mm distant from the periphery of the touch panel. The sliding was performed under the conditions of 100 times of sliding and a touch panel gap of 100 μm.

The linearity was measured as described below. Specifically, a voltage of 5 V was applied to the transparent conductive laminate, and the linearity was obtained by the method below using the output voltage E_{A} at the measurement start point A, the output voltage E_{B} at the measurement end point B, the output voltage E_{X} at the measurement point, and the theoretical value E_{XX}.

Specifically, after the sliding on each touch panel, a voltage of 5 V was applied to the transparent conductive laminate, and the linearity was obtained by the calculation using the output voltage E_{A} at the measurement start point A, the output voltage E_{B} at the measurement end point B, the output voltage E_{X} at the measurement point, and the theoretical value E_{XX} according to the mathematical expressions below. FIG. 4 is a graph showing the relationship between the voltage value at the touch panel obtained in example 1 and the measurement point. In the 2 0 graph, the solid line indicates actual measurement values, and the dotted line indicates theoretical values. The surface pressure durability was evaluated from the resulting linearity value. The results are shown in table 1.

E_{XX}(theoretical value)=×(E_{B}−E_{A})/(B−A)+E_{A} Linearity(%)={(E_{XX}−E_{X})/(E_{B}−E_{A})}×100 [Equation 1]

TABLE 1

| | Transparent base | | Evaluations | | | | |
|---|---|---|---|---|---|---|---|
| | Substrate | | | | | | Surface- |
| | Number of | Total | | Surface | Visible Light | | Pressure |
| | Laminated | Thickness | Sputtering | Resistance | Transmittance | | Durability |
| | Base Films | (μm) | Rate (nm) | (Ω/square) | (%) | Hue b* | (%) |
| Example 1 | 2 | 170 | 32 | 450 | 90 | 0.2 | 2 |
| Example 2 | 2 | 170 | 32 | 450 | 90 | 0.2 | 3 |
| Example 3 | 2 | 170 | 35 | 450 | 90 | 0.2 | 1.8 |
| Comparative | 1 | 125 | 32 | 450 | 90 | 0.2 | 8 |
| Example 1 | | | | | | | |
| Comparative | 1 | 125 | 32 | 450 | 90 | 0.2 | 8 |
| Example 2 | | | | | | | |

As shown in table 1, the transparent conductive laminate of each example has the first transparent dielectric thin film with high refractive index and high transparency and allows easy optical adjustment. The first transparent dielectric thin film also has a high resistance value, and the electrical conductivity of the transparent conductive laminate is not reduced. In each example, the sputtering rate and the productivity are also good. It is also apparent that the touch panel according to each example has good surface-pressure durability. In particular, the use of the specific first transparent dielectric thin film as described in each example can increase the surface-pressure durability.

What is claimed is:

1. A transparent conductive laminate, comprising:
a first transparent dielectric thin film;
a second transparent dielectric thin film;
a transparent conductive thin film;
a transparent film substrate having a thickness of 2 μm to 200 μm, and the first transparent dielectric thin film, the second transparent dielectric thin film, and the transparent conductive thin film formed on one side of the substrate in this order;
a transparent pressure-sensitive adhesive layer; and
a transparent base substrate bonded to another side of the transparent film substrate with a transparent pressure-sensitive adhesive layer interposed therebetween, wherein
the first transparent dielectric thin film is formed by vacuum deposition, sputtering or ion plating and comprises a complex oxide containing 100 parts by weight of indium oxide, 0 to 20 parts by weight of tin oxide and 10 to 40 parts by weight of cerium oxide,
a refractive index n1 of the first transparent dielectric thin film, a refractive index n2 of the second transparent dielectric thin film, and a refractive index n3 of the transparent conductive thin film satisfy a relationship: n2<n3≦n1, and
the transparent base substrate is a transparent laminated base substrate having at least two transparent base films that are laminated with the transparent pressure-sensitive adhesive layer interposed therebetween.

2. The transparent conductive laminate according to claim 1, wherein the first transparent dielectric thin film has a thickness of 10 nm to 200 nm and a surface resistance of 1×10⁶ Ω/square or more.

3. The transparent conductive laminate according to claim 1, further comprising a resin layer provided on an outer surface of the transparent base substrate.

4. A touch panel, comprising;
a pair of panel plates each having a transparent conductive thin film; and
a spacer interposed between a pair of the panel plates opposed to each other in such a manner that the transparent conductive thin films are opposed to each other, wherein
at least one of a pair of the panel plates comprises the transparent conductive laminate according to claim 1.
